(19) United States
(12) Patent Application Publication
(10) Pub. No.: US 2022/0320566 A1
(43) Pub. Date: Oct. 6, 2022

(54) ELECTROCHEMICAL CELL AND ITS METHOD OF MANUFACTURE

(71) Applicant: SAFT, Levallois-Perret (FR)

(72) Inventor: Gerard RIGOBERT, FARGUES St. HILAIRE (FR)

(73) Assignee: SAFT, Levallois-Perret (FR)

(21) Appl. No.: 17/626,957

(22) PCT Filed: Jul. 10, 2020
(86) PCT No.: PCT/EP2020/069476

§ 371 Date: Jan. 13, 2022

(30) Foreign Application Priority Data
Jul. 19, 2019 (FR) FR1908216

(51) Int. Cl. H01M 10/04; H01M 10/0585

(52) U.S. Cl. CPC H01M 10/0422; H01M 10/049; H01M 10/0481; H01M 10/0585

(57) ABSTRACT

The invention concerns an electrochemical element and the method for manufacturing same, as well as a battery comprising one or more electrochemical elements, for application in particular in the field of electrochemical elements or Li-ion batteries. The electrochemical element comprises a closed shell (1) defining an internal volume inside which a bundle (2) is arranged, having alternating positive and negative electrodes (3) respectively connected to two positive and negative electrical output terminals and housing separators, the bundle (2) being impregnated with electrolyte. The shell (1) comprises a bottom wall (4) having an internal bottom face (4a), oriented towards the internal volume, and at least one side wall (5, 6) having an internal side face (5a, 6a), oriented towards the internal volume. The internal side face (5a, 6a) joins the internal bottom face (4a) by substantially forming an internal angle (a).

### FIELD OF THE INVENTION

The invention relates to an electrochemical cell and to a method for the manufacture thereof, and to a battery comprising one or more electrochemical cells. It finds particular application in the field of electrochemical cells or Li-ion batteries, and in particular aims to optimize the volume and electrical capacity of such cells, more generally optimization of their volumetric and gravimetric energy density.

### BACKGROUND ART

As can be seen in a simplified and cross-sectional view in FIG. 1a, an electrochemical cell, for example in the form of a parallelepipedal or a cylindrical assembly, generally comprises a casing 1, closed for example by a cover, which defines an internal volume. Inside this volume is arranged an electrode plate group 2 impregnated with electrolyte, comprising an alternation of positive and negative electrodes 3. These electrodes 3 are respectively connected to two positive and negative electrical output terminals (not shown) and surround the separators (also not shown).

The casing 1 comprises a bottom wall 4 which has an inner bottom face 4a, facing towards the internal volume, one or more side walls 5, 6 having an inner side face 5a, 6a facing the internal volume.

As can be seen clearly in FIG. 1a, the side walls 5, 6 of the casing 1 join the bottom wall forming a rounded shape, in particular on the inner side, that is to say at the junction between each inner side face 5a, 6a and the inner bottom face 4. In order to obtain the volume of the casing 1 as shown in FIG. 1a, a metal foil, preferably aluminum, is drawn out. In this way, an inner die or punch and an outer die which are actuated relative to each other by a press are used, the dies having respective shapes and dimensions which make it possible to obtain the desired volume: for example, a cylindrical punch and a hollow cylindrical outer die for a cylindrical volume, or a parallelepiped punch and a hollow parallelepiped outer die for obtaining a parallelepiped volume.

The punch and the outer die have a bottom that joins the at least one side wall with a rounding, so as not to damage the metal foil during the deep drawing operation. It is not possible to use an angular punch or an angled outer die, without risking the casing at the corners, which would lead to an unacceptable risk of tearing, or even without tearing the casing during the deep drawing operation in particular due to the fact that the casing tends to adhere to the punch and/or the outer die. Even using oil during the deep drawing operation, it is impossible to peel off the formed casing with a punch and/or an angled outer die without damaging it.

Further, a punch and an angled outer die are subject to substantial wear, which is not compatible with industrial mass manufacture.

However, one of the problems posed by the presence of the rounded edges at the bottom of the volume defined by the casing is that it can cause local curvature on the electrodes in the vicinity of the side walls, by packing them down towards the bottom. This can cause electrical short circuits. Additional elements to be inserted into the bottom of the casing can be provided to avoid this packing. But this makes the manufacturing process longer and more expensive and leads to an electrical capacity loss for the electrochemical cell. More generally, this phenomenon results in a decrease in volumetric and gravimetric energy density of the electrochemical cell.

In addition, the presence of these rounded edges reduces the heat exchange surface at the bottom wall. Now, dissipation of heat inside the electrochemical cell is a significant factor, and this is mainly by heat exchange at this bottom wall, in particular when several electrochemical cells are laterally juxtaposed to form a battery.

As shown in FIG. 1B, one solution consists in producing a chamfer 12 in the bottom part of the electrodes, forming the electrode plate group 2, located close to the respective side wall 5 or 6, in order to limit the packing phenomenon. However, in this configuration, the heat exchange surface remains limited, since there is no exchange at the low chamfered part 12 of the electrodes, therefore at the rounded junction between the bottom wall 4 and the side wall 5 or 6 of the casing 1 concerned. In addition, this solution complicates manufacturing since additional re-cutting operations of the electrodes must be carried out.

### SUMMARY OF THE INVENTION

One of the aims of the invention is therefore to resolve in particular the abovementioned problems. Thus, the aim of the invention is to provide an electrochemical cell with optimized volumetric and gravimetric energy density, and better capacity to dissipate the internal heat generated by the operation of the electrochemical cell.

The invention thus provides an electrochemical cell comprising a closed casing defining an internal volume inside which an electrode plate group having an alternation of positive and negative electrodes is arranged. These electrodes are respectively connected to two positive and negative electrical output terminals and surrounding separators. The electrode plate group is impregnated with electrolyte.

The casing further includes a bottom wall having an inner bottom face facing the internal volume, and at least one side wall having an inner side face facing the internal volume. The inner side face joins the inner bottom face with substantially the formation of an internal angle.

In the present application, by the expression “substantially forming an angle”, or “angular” should be taken to mean the joining of surfaces with the formation of a rounding of radius that is so small that it is considered that there is formation of an angle. The applicant/assignee considers that the presence of a rounding of radius substantially less than or equal to 0.5 mm corresponds to the formation of an angle. The concepts of angle, angular are therefore used in the present application to designate a junction between two walls forming a rounding of radius substantially less than or equal to 0.5 mm.

Also, as opposed to what has just been said, when the expression “rounding” is used without further precision, it designates the rounding at the junction between two walls as found in the prior art, and which is generally obtained by a deep drawing operation. Such a rounding is substantially greater than 0.5 mm.

In some embodiments, the electrochemical cell further comprises one or more of the following features, taken alone or following all technically possible combinations:
the bottom wall has the shape of a surface generating a solid of revolution, for example a circle, said at least one side wall substantially forming the side wall of a corresponding solid of revolution, for example a cylinder;
the bottom wall forms a polygon, for example a rectangle, and the casing comprises a plurality of side walls each having an inner side face facing the internal volume and joining the inner bottom face at one of the sides of said polygon, the inner side face of at least one of the side walls joining the inner bottom face with substantially the formation of an internal angle;
the inner side faces of each side wall meet the inner bottom face with substantially the formation of an internal angle, preferably the same as the internal angle formed by each inner side face with the bottom face;
the internal angle or at least one of the internal angles is substantially equal to 90°;
the bottom wall has an outer bottom face opposite the inner bottom face, and the at least one side wall each have an outer side face opposite the corresponding inner side face, the or at least one of the outer side faces joining the outer bottom face with substantially the formation of an outer angle, preferably substantially equal to the internal angle;
the external angle or at least one of the external angles is substantially equal to 90°;
the bottom wall and the at least one of the side walls are formed in a metal material, preferably aluminum.
the electrode plate group is of the Lithium-ion type.

The invention also provides, in a second aspect, a battery comprising one or more electrochemical cells electrically connected in parallel and/or in series, wherein at least one of the electrochemical cells is an electrochemical cell as described above.

The invention further provides a method for producing an electrochemical cell according to a third aspect of the invention.

The electrochemical cell includes a closed casing defining an internal volume within which is disposed an electrode plate group having an alternation of positive and negative electrodes respectively connected to two positive and negative electrical output terminals and surrounding separators. The electrode plate group is impregnated with electrolyte.

The casing includes a bottom wall having an inner bottom face oriented towards the internal volume, and at least one side wall having an inner side face oriented towards the internal volume.

The method comprises, prior to placing the electrode plate group and closing the casing, a step of volume-forming of the casing so as to obtain the internal volume with a junction between the internal side face and the internal bottom face which is substantially angular with a given internal angle.

In some embodiments, the method further comprises one or more of the following features, taken alone or following all technically possible combinations:
the casing is made of a metallic material, for example made of aluminum, and the step of volume-forming the casing comprises a step of volume-forming by magneto-forming comprising placing the casing to be formed in the vicinity of an electromagnetic field source, and placing a template made of non-electrically conductive material in the vicinity of the casing, the source being placed on a first side of the casing and the template being placed on a second side of the casing opposite the first side, the shape of the template being configured so as to allow the internal volume of the casing to be formed by pressing the casing against the template under the effect of an electromagnetic field generated by the source;
the first side of the casing to be formed is the side of the face of the casing intended to be oriented towards the internal volume after shaping, the template having at least one portion forming the internal volume in the form of a hollow;
the second side of the casing to be formed is the side of the face of the casing intended to be oriented towards the internal volume after shaping, the template having at least one portion forming the internal volume;
the volume-forming step comprises, prior to the step of volume-forming by magneto-forming, a step of volume-forming by deep drawing, so as to prepare the casing to be formed by creating an intermediate internal volume with a substantially rounded junction between the inner side face and the inner bottom face.

Thus, the electrochemical cell and the battery according to the invention make it possible to reduce or even eliminate the unused bottom area in the cells of the prior art, make it possible to avoid the phenomenon of local packing of the electrodes in the vicinity of the side walls and the bottom, and enable better heat dissipation due to a larger surface area for heat exchange at the bottom wall.

### BRIEF DESCRIPTION OF THE DRAWINGS

The features and advantages of the invention will become apparent upon reading the following description, given by way of example, and non-limiting, with reference to the following drawings.

FIG. 1a and FIG. 1B are diagrammatic representations of two examples of electrochemical cell of the prior art;

FIG. 2 is a diagrammatic representation of an example of an electrochemical cell of the invention;

FIG. 3 and FIG. 4 are diagrammatic representations of a first example of the implementation of the method of the invention;

FIG. 5 and FIG. 6 are diagrammatic representations of a second example of the implementation of the method of the invention.

### DETAILED DESCRIPTION OF THE INVENTION

FIG. 2 shows an exemplary embodiment of an electrochemical cell of the invention, seen in cross-section, in the form of a parallelepiped assembly.

The electrochemical cell therefore comprises a casing 1, closed for example by a cover (not shown), and defining an internal volume. This internal volume is substantially parallelepipedal in this example.

The casing 1 is preferably formed in part or in whole in a metallic material, such as aluminum.

Within the internal volume defined by the casing 1, an electrode plate group 2 is arranged. Conventionally, this electrode plate group 2 comprises an alternation of positive and negative electrodes 3 connected respectively to two positive and negative electrical output terminals (not shown). Depending on the type of electrochemical cell, the two output terminals can, for example, be arranged at the top, at the cover. Alternatively, and also by way of example, one of the terminals may be disposed at the top, at the cover, the other being disposed at the bottom region, at the bottom wall 4.

The electrodes 3 surround separators (not shown), and the electrode plate group 2 is impregnated with electrolyte. It can be, for example, a Lithium-ion electrode plate group 2.

The casing 1 comprises in particular a bottom wall 4 and at least one side wall 5, 6. In the example shown in FIG. 2, the internal volume is substantially parallelepiped, the bottom wall 4 is substantially rectangular, as well as the four side walls including the two side walls 5 and 6. These considerations relate to the case of an electrochemical cell whose casing 1 has a bottom part 4 of polygonal shape, with as many side walls 5, 6 extending from the bottom wall 4 than there are segments in this polygon.

Also, FIG. 2 could also represent an electrochemical cell in the form of an assembly corresponding to a solid of revolution, for example a cylindrical shape, therefore with an internal volume defined by a casing 1 corresponding substantially to the volume of a solid of revolution, for example a cylinder. In this case, the bottom wall 4 has the shape of a surface generating a solid of revolution, for example a circle. In this case, only one side wall 5 or 6 rises from the bottom wall 4 to form the body of the solid of revolution, for example of the cylinder.

In the remainder of the description, reference will be made to the side wall 5, 6, just as well to designate any of the two 5 or 6, or both 5 and 6, or the whole of the side walls of the casing 1 of an electrochemical cell, the casing 1 of which effectively comprises several side walls, as to designate the single side wall of the casing 1 of an electrochemical cell of the overall shape of an assembly corresponding to a solid of revolution.

The bottom wall has an inner bottom face 4a, facing the internal volume defined by the casing 1, and an outer bottom face 4b opposite the inner bottom face 4a, therefore facing the outside of the internal volume defined by the casing 1.

Each side wall 5, 6 also has an internal side face 5a, 6a facing the internal volume to defined by the casing 1, and an external side face 5b, 6b opposite the corresponding internal side face 5a, 6a, therefore oriented towards the outside of the internal volume defined by the casing 1.

The inner side face 5a, 6a of at least one of the side walls 5, 6, preferably of all the side walls 5, 6, joins the inner bottom face 4a with substantially the formation of an internal angle (a).

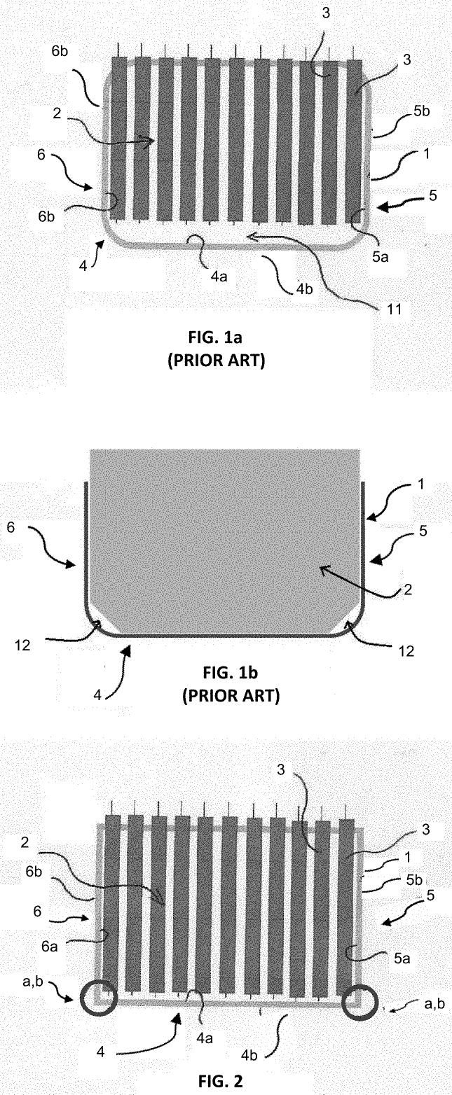

Thus, as can be seen in comparison with FIG. 1a representing an electrochemical cell of the prior art, the unused area 11 present in FIG. 1a does not exist in FIG. 2. By virtue of the presence of the internal angles (a), the electrode plate group 2, in particular the electrodes 3 closest to the side walls 5, 6, can extend to the bottom wall 4 without being crushed against the rounded edges present in the example of FIG. 1a.

In the example shown in FIG. 2, each of the internal angles (a) between the inner face 4a of the bottom wall 4 and the inner face 5a, 6a of one of the side walls 5, 6 are identical, preferably substantially equal to 90°. But other configurations are possible, with different internal angles (a) from one side wall 5, 6 to the other.

Preferably, the outer side face 5b, 6b of at least one of the side walls 5, 6 also joins the outer bottom face 4b of the bottom wall 4 with substantially the formation of an external angle (b). This external angle (b) may be different from the internal angle or angles (a), but is preferably substantially equal to that of the at least one internal angle (a), for example substantially equal to 90°.

As already mentioned above, all or part of the casing 1 is preferably made of a metallic material, such as aluminum. In particular, the bottom wall 4 and the at least one of the side walls 5, 6 are formed in this material.

A plurality of electrochemical cells may be electrically connected, including one or more electrochemical cells as described above, in parallel and/or in series, to form a battery.

In order to obtain the electrochemical cell of the invention, the volume of the casing 1 is created, prior to the placement of the electrode plate group 2 and the closure of the casing 1.

The starting material is a sheet formed from the desired material, preferably metallic (such as aluminum), and preferably of circular shape.

The volume-forming step is designed to allow the desired internal volume to be obtained, with a junction between the internal side face 5a, 6a of at least one of the side walls 5, 6 and the internal bottom face 4a of the bottom wall, substantially angular with internal angle (a).

Preferably, the material of the sheet intended to form the casing 1 after shaping is therefore metallic. In the following, reference to casing 1 can just as well designate the casing 1 which has been given its volume as this same casing 1 during the volume-forming operation, and thus including the planar sheet at the base of the casing before any volume formation.

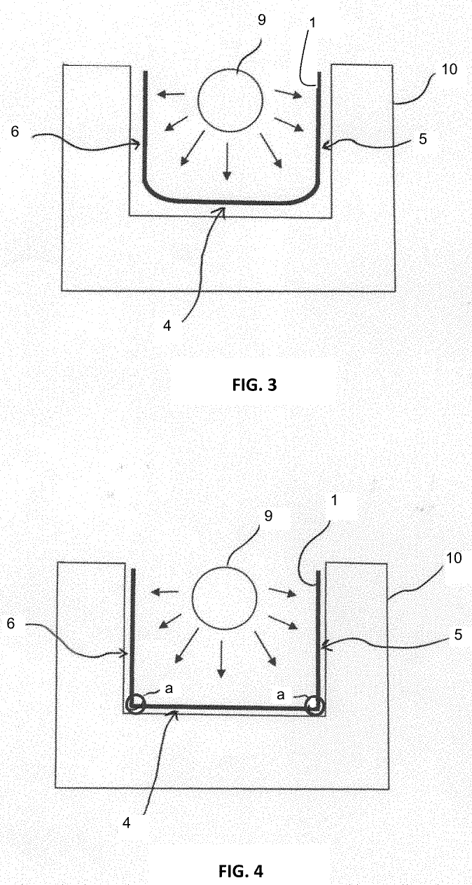

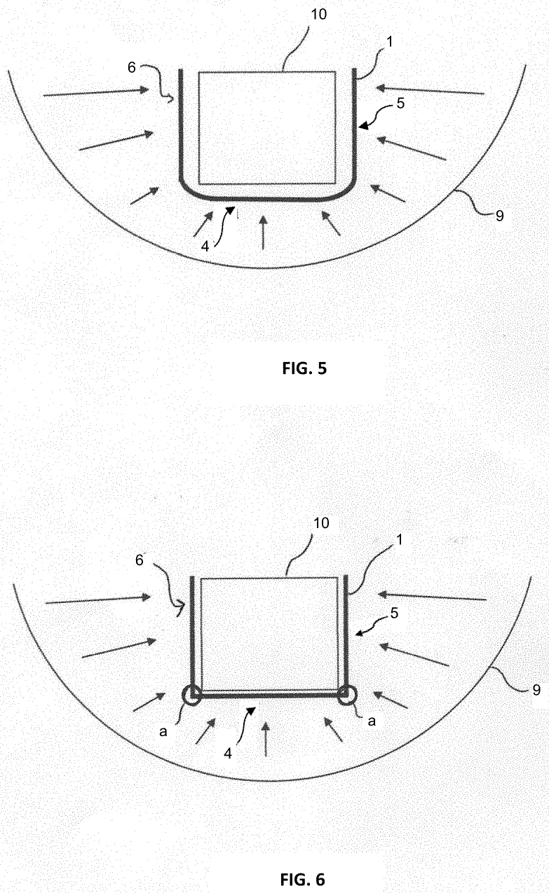

In order to obtain the desired volume, a magneto-forming volume shaping step is carried out, as shown in two examples in FIGS. 3 and 4, respectively FIGS. 5 and 6. The conventional magneto-forming principle, known to a person skilled in the art, is that of the use of the viscoelastic properties of the material used, in order to obtain the desired deformation by applying a series of high intensity electromagnetic pulses. The casing 1 to be formed is first positioned in the vicinity of an electromagnetic field source 9. Furthermore, a template 10 made of a non-electrically conductive material is positioned in the vicinity of the casing 1. Specifically, the source 9 is placed on a first side of the casing 1 and the template 10 is placed on a second side of the casing 1 opposite the first side.

In the example of FIGS. 3 and 4, the first side of the casing 1 to be formed is the side of the face of the casing 1 intended to be oriented towards the internal volume after shaping. The source 9 is therefore placed on the side of the internal volume to be formed, and the template 10 is placed on the external side. The latter has at least one portion forming the internal volume in the form of a hollow, for example a parallelepiped or a cylinder.

In the example of FIGS. 5 and 6, the second side of the casing 1 to be formed is the side of the face of the casing 1 intended to be oriented towards the internal volume after shaping. The source 9 is therefore placed on the outer side, and the template 10 is placed on the side of the internal volume to be formed. The latter has at least one portion forming the internal volume, for example a parallelepiped or a cylinder.

The shape of the template 10 is thus configured so as to allow the internal volume of the casing 1 to be formed by pressing the casing 1 against the template 10 under the effect of an electromagnetic field generated by the source 9.

Preferably, as shown in FIGS. 3 and 5, prior to the implementation of the volume-forming step by magneto-forming, a step of volume-forming is carried out by deep drawing, so as to prepare the casing 1 to be shaped. A casing 1 is then obtained having substantially the shape shown in FIGS. 3 and 5, that is to say that the intermediate internal volume created by deep drawing is such that the junction between the internal side face 5a, 6a of the one or more of the side walls 5, 6 and the inner bottom face 4a of the bottom wall, is substantially rounded.

FIGS. 3 and 5 therefore represent an intermediate state of casing 1, after the shaping by deep drawing and before the end of the shaping by magneto-forming.

The applicant/assignee has thus been able to ascertain a significant increase in volumetric and gravimetric energy density, by completely or partly removing the unused area 11 materialized in FIG. 1a relating to the prior art, as well as an increase in the heat exchange surface at the bottom wall 4.

In the example of an electrochemical cell with a rectangular bottom wall 4 of outer dimensions 26.5 mm×148 mm, an increase in 5% of the useful volume has been measured, which avoids the packing of electrodes mentioned above and leads to the increase in volumetric and gravimetric energy density, thanks to the obtaining of internal junctions between the side walls 5, 6 and the bottom wall 4 with an angle substantially equal to 90°. Furthermore, an increase in 20% of the heat exchange surface at the bottom wall 4 has been measured by virtue of these internal junctions at substantially right angles, in particular compared to an electrochemical cell of the prior art as shown in FIG. 1B.

It should be borne in mind that the present description is given by way of example and is not limiting of the invention. In particular, in this description, an example of an electrochemical cell of the Li-ion type and of substantially parallelepipedal assembly form is presented in the drawings. Nevertheless, all the considerations presented in this description, except where explicitly mentioned, apply to an electrochemical cell of a type other than Li-ion and another assembly shape other than a strictly parallelepipedal shape, for example a cylindrical shape.

1. A method for manufacturing an electrochemical cell, said electrochemical cell comprising a closed casing defining an internal volume inside which is arranged an electrode plate group comprising an alternation of positive and negative electrodes connected respectively to two positive and negative electrical output terminals and surrounding separators, said electrode plate group being impregnated with electrolyte, the casing being made of a metallic material and comprising a bottom wall having an inner bottom face, oriented towards the internal volume, and at least one side wall having an inner side face, oriented towards the internal volume,
said method comprising, prior to placing the electrode plate group and closing the casing, a step of volume-forming of the casing,
wherein the volume-forming step comprises a step of volume-forming by magneto-forming comprising placing the casing to be formed in the vicinity of an electromagnetic field source, and placing a template made of non-electrically conductive material close to the casing, said source being placed on a first side of the casing and said template being placed on a second side of the casing opposite the first side, the shape of the template being configured so as to allow the internal volume of the casing to be formed by pressing the casing against the template under the effect of an electromagnetic field generated by the source, and to obtain an angular junction between the inner side face and the inner bottom face, having an internal angle (a).

2. The method according to claim 1, wherein a first side of the casing to be formed is the side of the face of the casing intended to be oriented towards the internal volume after shaping, said template having at least one portion forming the internal volume in the form of a hollow.

3. The method according to claim 1, wherein a second side of the casing to be formed is the side of the face of the casing intended to be oriented towards the internal volume after shaping, the template having at least one portion forming the internal volume.

4. The method according to claim 1, wherein the volume-forming step comprises, prior to the step of volume-forming by magneto-forming, a step of volume-forming by deep drawing, so as to prepare the casing to be formed by creating an intermediate internal volume with a substantially rounded junction between the inner side face and the inner bottom face.

5. The method according to claim 1, wherein the bottom wall has the shape of a surface generating a solid of revolution, for example a circle, said at least one side wall substantially forming the side wall of a corresponding solid of revolution, for example a cylinder.

6. The method according to claim 1, wherein the bottom wall forms a polygon, for example a rectangle, and the casing comprises a plurality of side walls each having an inner side face facing the internal volume and joining the inner bottom face at one of the sides of said polygon, the inner side face of at least one of the side walls joining the inner bottom face with substantially the formation of an internal angle (a).

7. The method according to claim 6, wherein the inner side faces of each side wall meet the inner bottom face with substantially the formation of an internal angle (a), preferably identical to the internal angle (a) formed by each inner side face with the bottom face.

8. The method according to claim 1, wherein the internal angle (a) is substantially equal to 90°.

9. The method according to claim 1, wherein the bottom wall has an outer bottom face opposite the inner bottom face, and the at least one side wall each have an outer side face opposite the corresponding inner side face, the or at least one of the outer side faces joining the outer bottom face with substantially the formation of an external angle (b), preferably substantially equal to the internal angle (a).

10. The method according to claim 9, wherein the external angle (b) is substantially equal to 90°.

11. The method according to claim 1, wherein the bottom wall and the at least one of the side walls formed of aluminum.

12. The method according to claim 1, wherein the electrode plate group is of the Lithium-ion type.
